(19) United States
(12) Patent Application Publication
(10) Pub. No.: US 2005/0262340 A1
(43) Pub. Date: Nov. 24, 2005

(54) Methods and systems in a computer network for enhanced electronic document security

(75) Inventor: Khalid M. Rabb, Fairport, NY (US)

Correspondence Address: ORTIZ & LOPEZ, PLLC;Patent Attorneys, P.O. Box 4484, Albuquerque, NM, 87196-4484, US

(73) Assignee: Xerox Corporation

(21) Appl. No.: 10/839,692

(22) Filed: May 4, 2004

(51) Int. Cl. H04L 9/00

(52) U.S. Cl. 713/165

(57) ABSTRACT

Methods and systems for scanning and encrypting documents are disclosed. A document can be scanned utilizing a scanning device. The document can then be converted into image formatted data representative of the document. The image formatted data can then be encrypted at the scanning device utilizing an encryption key prior to transmitting the image formatted data to its final destination. The image formatted data can be decrypted utilizing an encryption key after the image formatted data is delivered to its final destination, which can be, for example, a rendering device such as a copier or printer linked to a computer network and/or a computer network client and/or a computer network storage device.

### TECHNICAL FIELD

Embodiments are generally related to data-processing systems. Embodiments are also related to methods and systems for obtaining and rendering data. Embodiments are additionally related to security and encryption and decryption techniques.

### BACKGROUND OF THE INVENTION

Data processing systems and computer networks are being increasingly incorporated into the modern workplace. Scanning devices, multifunction printers, personal computers, digital copiers and other electronic document generating devices have become commonplace tools for most office workers. Typically, much of the work product of such devices is intended to be transformed into hardcopy via a printer using digital imaging technology. A typical printer configuration for this purpose, for example, comprises a dedicated printer coupled to the personal computer (“PC”). Printers, utilized for this purpose, however are typically small laser or ink-jet printers, which have limited functions and features such as a limited tray capacity which restricts the number and types of copy sheets that can be used to make prints on, or which do not have a finishing capability, etc. More importantly small laser printers also typically handle only one page description language (PDL), and do not have a document scanning capability for scanning and printing documents.

On the other hand, larger high speed laser printers normally have a great deal of finishing and copy sheet capability which would allow the PC user to have, for example, custom printing and finishing of his or her work product, an option which for many office workers would be desirable. In practice, the PCs can be used advantageously with a network printing system of the type combining a number of client inputs, such as input scanners, PCs, workstations, or the like, and one or more printer outputs.

In one example of such network printing systems, a client at one of the inputs sends electronic documents that comprise a job over a local area network (LAN) to one of the printers selected for printing the job. In particular, LANs provide a means by which users running dedicated processors are able to share resources such as printers, file servers and scanners. Integration of shared resources has been a problem addressed by LAN managers. LAN managers have made different network protocols such as Ethernet and Token Ring transparent to devices running different network protocols.

LANs also have a variety of print drivers emitting different PDLs, which are directed to specific printer devices. In addition, different input scanners also have different image formats. Digital copiers which communicate with a computer network such as a LAN are often utilized not only to copy documents, but also to scan large numbers of documents and transfer the documents for storage on network servers or client workstations. Digital copiers can thus be utilized to enhance the capabilities of other devices, such as printers, scanners, file servers, and so forth. Such documents and data can then be rendered later at a final destination selected by the user.

Current data-processing systems and computer networks over which scanned documents are obtained and rendered are vulnerable to a number of security risks. Current systems typically send scanned files from a scanning device over a computer network for filing, e-mail, or other intermediate processing followed by distribution to its final destination, which may be, for example a network client or network storage device. Data transferred over a computer network is usually converted into image formatted data (e.g., TIFF, JPEG, PDF, etc.) prior to transmission over the computer network. The computer network is therefore potentially open to hacker activity. While final access to the data (e.g., files, documents, etc.) may be protected by e-mail security and/or file server policies, nothing really prevents user data from being grabbed off the network by a sniffer trace or other intrusive software module and being readily decoded.

### BRIEF SUMMARY

It is, therefore, a feature of the present invention to provide for an improved data-processing system.

It is another feature of the present invention to provide for improved methods and systems for obtaining and rendering data, such as scanned documents converted to image formatted data.

It is a further feature of the present invention to provide for improved encryption and decryption techniques applicable to data transferred to and from networked scanning, multifunction and rendering devices.

Aspects of the present invention relate to methods and systems for scanning and encrypting documents. A document can be scanned utilizing a scanning device. The document can then be converted into image formatted data representative of the document. The image formatted data can then be encrypted at the scanning device utilizing an encryption key prior to transmitting the image formatted data to its final destination. The image formatted data can be decrypted utilizing an encryption key after the image formatted data (e.g., PDF, TIFF, JPEG, etc.) is delivered to its final destination, which can be, for example, a rendering device such as a copier or printer linked to a computer network. Embodiments disclosed herein generally permit the encryption of scanned data sent “off the box”. Such data can be encrypted utilizing a variety of encryption techniques, such as, for example, fixed encryption and/or public key encryption.

Directory data can be made available to use after a user authenticated login procedure, entry of a local key, and/or the availability of a generic key for the scanning device, a key provided by a security card (e.g., a smart card, swipe card, etc.). Upon receipt of the file/document, the user can then decrypt the file and view its contents. The embodiments disclosed herein thus describe a scanner or multifunction device function that provides a user with the option to encrypt jobs prior to sending such jobs to their final destination (e.g., client or network storage device). Once at the client, the job can be decrypted and stored according to normal storage procedures. Such embodiments can prevent unauthorized individuals from viewing the data.

### BRIEF DESCRIPTION OF THE DRAWINGS

The accompanying figures, in which like reference numerals refer to identical or functionally-similar elements throughout the separate views and which are incorporated in and form part of the specification further illustrate embodiments of the present invention.

FIG. 1 illustrates a pictorial representation of a computer system in which a preferred embodiment of the present invention can be implemented;

FIG. 2 illustrates a block diagram of a representative hardware environment of the processing unit of the computer system depicted in FIG. 1;

FIG. 3 illustrates a high-level flow chart of operations depicting logical operational steps that can be implemented in accordance with a preferred embodiment of the present invention;

FIG. 4 illustrates a high-level flow chart of operations depicting continuing logical operational steps that can be implemented in accordance with a preferred embodiment of the present invention;

FIG. 5 illustrates a block diagram of a network in which a preferred embodiment can be implemented; and

FIG. 6 illustrates a high-level flow chart of operations depicting logical operational steps that can be implemented in accordance with an alternative embodiment of the present invention.

### DETAILED DESCRIPTION OF THE INVENTION

The particular values and configurations discussed in these non-limiting examples can be varied and are cited merely to illustrate embodiments of the present invention and are not intended to limit the scope of the invention.

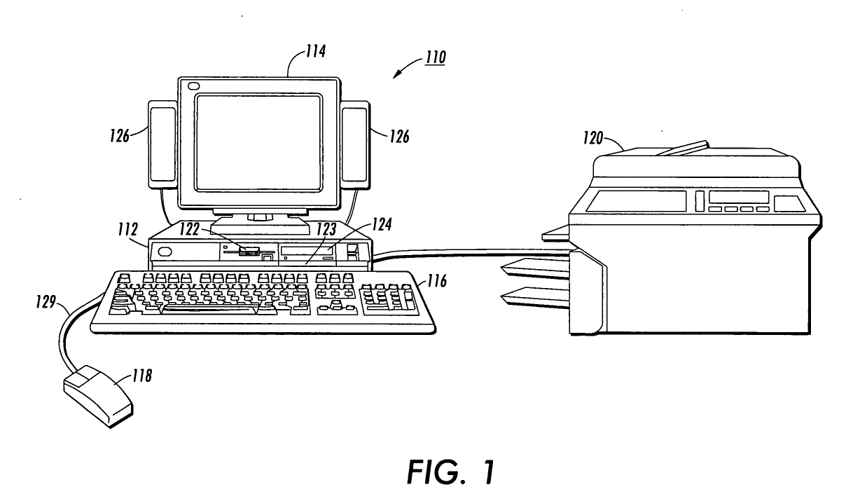

With reference now to the figures and in particular with reference to FIG. 1, there is depicted an embodiment of a computer system that can be utilized to implement the preferred embodiment. Data-processing system 110 includes processing unit 112, display device 114, keyboard 116, pointing device 118, rendering device 120, and speakers 126. Rendering device 120 can be implemented as a device such as a printer and/or scanner. Processing unit 112 receives input data from input devices such as keyboard 116, pointing device 118, and local area network interfaces (not illustrated) and presents output data to a user via display device 114, printer 120, and speakers 126. Because processing unit 112 can be networked into a computer network, devices such as rendering device 120 can function as a network device such as a network scanner or multifunction device. Data-processing system 110 thus can function not only as a stand-alone desktop personal computer, but can also function as a networked data-processing system with multifunction capabilities such as printing, scanning, copying and so forth.

Keyboard 116 is that part of data-processing system 110 that resembles a typewriter keyboard and that enables a user to control particular aspects of the computer. Because information flows in one direction, from keyboard 114 to processing unit 112, keyboard 116 functions as an input-only device. Functionally, keyboard 116 represents half of a complete input/output device, the output half being video display terminal 114. Keyboard 116 includes a standard set of printable characters presented in a “QWERTY” pattern typical of most typewriters. In addition, keyboard 116 includes a calculator-like numeric keypad at one side. Some of these keys, such as the “control,” “alt,” and “shift” keys can be utilized to change the meaning of another key. Other special keys and combinations of keys can be utilized to control program operations or to move either text or cursor on the display screen of video-display terminal 114.

Video-display terminal 114 is the visual output of data-processing system 110. As indicated herein, video-display terminal 114 can be a cathode-ray tube (CRT) based video display well-known in the art of computer hardware. But, with a portable or notebook-based computer, video-display terminal 114 can be replaced with a liquid crystal display (LCD) based or gas, plasma-based, flat-panel display.

Pointing device 118 is preferably utilized in conjunction with a graphical user-interface (GUI) in which hardware components and software objects are controlled through the selection and the manipulation of associated, graphical objects displayed within display device 114. Although data-processing system 110 is illustrated with a mouse for pointing device 118, other graphical-pointing devices such as a graphic tablet, joystick, track ball, touch pad, or track pad could also be utilized. Pointing device 118 features a casing with a flat bottom that can be gripped by a human hand. Pointing device 118 can include buttons on the top, a multidirectional-detection device such as a ball on the bottom, and cable 129 that connects pointing device 118 to processing unit 112.

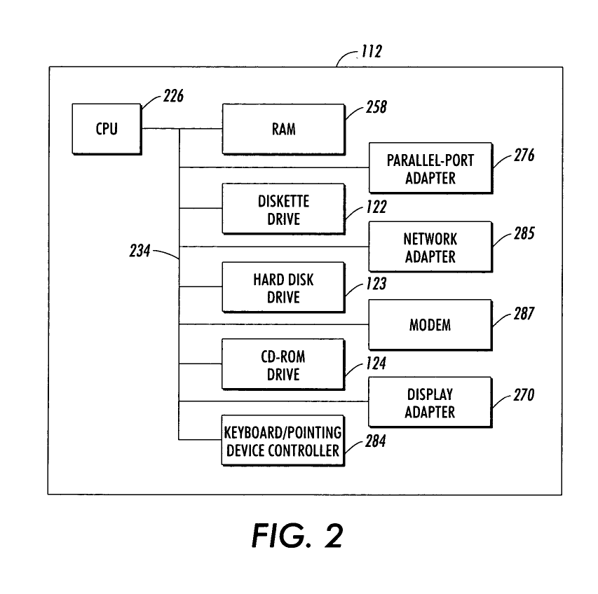

To support storage and retrieval of data, processing unit 112 further includes diskette drive 122, hard-disk drive 123, and CD-ROM drive 124, which are interconnected with other components of processing unit 112, and which are further described below under the description for FIG. 2. Data-processing system 110 can be implemented utilizing any suitable computer. But, a preferred embodiment of the present invention can apply to any hardware configuration that allows the display of windows, regardless of whether the computer system is a complicated, multi-user computing apparatus, a single-user workstation, or a network appliance that does not have non-volatile storage of its own.

Referring to FIG. 2, there is depicted a block diagram of the principal components of processing unit 112. CPU 226 is connected via system bus 234 to RAM (Random Access Memory) 258, diskette drive 122, hard-disk drive 123, CD-ROM drive 124, keyboard/pointing-device controller 284, parallel-port adapter 276, network adapter 285, display adapter 270, and modem 287. Although the various components of FIG. 2 are drawn as single entities, each may consist of a plurality of entities and may exist at multiple levels.

Processing unit 112 includes central processing unit (CPU) 226, which executes instructions. CPU 226 includes the portion of data-processing system 110 that controls the operation of the entire computer system, including executing the arithmetical and logical functions contained in a particular computer program. Although not depicted in FIG. 2, CPU 226 typically includes a control unit that organizes data and program storage in a computer memory and transfers the data and other information between the various parts of the computer system. CPU 226 generally includes an arithmetic unit that executes the arithmetical and logical operations, such as addition, comparison, and multiplication. CPU 226 accesses data and instructions from and stores data to volatile RAM 258.

CPU 226 can be implemented, for example, as any one of a number of processor chips, or any other type of processor, which are available from a variety of vendors. Although data-processing system 110 is shown to contain only a single CPU and a single system bus, the present invention applies equally to computer systems that have multiple CPUs and to computer systems that have multiple buses that each performs different functions in different ways.

RAM 258 comprises a number of individual, volatile-memory modules that store segments of operating system and application software while power is supplied to data-processing system 110. The software segments are partitioned into one or more virtual-memory pages that each contains a uniform number of virtual-memory addresses. When the execution of software requires more pages of virtual memory than can be stored within RAM 258, pages that are not currently needed are swapped with the required pages, which are stored within non-volatile storage devices 122 or 123. RAM 258 is a type of memory designed such that the location of data stored in it is independent of the content. Also, any location in RAM 258 can be accessed directly without needing to start from the beginning.

Hard-disk drive 123 and diskette drive 122 are electromechanical devices that read from and write to disks. The main components of a disk drive are a spindle on which the disk is mounted, a drive motor that spins the disk when the drive is in operation, one or more read/write heads that perform the actual reading and writing, a second motor that positions the read/write heads over the disk, and controller circuitry that synchronizes read/write activities and transfers information to and from data-processing system 110.

A disk itself is typically a round, flat piece of flexible plastic (e.g., floppy disk) or inflexible metal (e.g. hard disk) coated with a magnetic material that can be electrically influenced to hold information recorded in digital form. A disk is, in most computers, the primary method for storing data on a permanent or semi permanent basis. Because the magnetic coating of the disk must be protected from damage and contamination, a floppy disk (e.g., 5.25 inch) or micro-floppy disk (e.g., 3.5 inch) is encased in a protective plastic jacket. But, any size of disk could be used. A hard disk, which is very finely machined, is typically enclosed in a rigid case and can be exposed only in a dust free environment. Keyboard/pointing-device controller 284 interfaces processing unit 112 with keyboard 116 and graphical-pointing device 118. In an alternative embodiment, keyboard 116 and graphical-pointing device 118 have separate controllers. Display adapter 270 can translates graphics data from CPU 226 into video signals utilized to drive display device 114.

Finally, processing unit 112 includes network adapter 285, modem 287, and parallel-port adapter 276, which facilitate communication between data-processing system 110 and peripheral devices or other computer systems. Parallel-port adapter 276 transmits printer-control signals to printer 120 through a parallel port. Network adapter 285 connects data-processing system 110 to an un-illustrated local area network (LAN). A LAN provides a user of data-processing system 110 with a means of electronically communicating information, including software, with a remote computer or a network logical-storage device. In addition, a LAN supports distributed processing, which enables data-processing system 110 to share a task with other computer systems linked to the LAN., which can also be implemented in the context of a wireless local area network (WLAN).

Modem 287 supports communication between data-processing system 110 and another computer system over a standard telephone line. Furthermore, through modem 287, data-processing system 110 can access other sources such as a server, an electronic bulletin board, and the Internet or the well-known World Wide Web.

The configuration depicted in FIG. 1 is but one possible implementation of the components depicted in FIG. 2. Portable computers, laptop computers, and network computers or Internet appliances are other possible configurations. The hardware depicted in FIG. 2 may vary for specific applications. For example, other peripheral devices such as optical-disk media, audio adapters, or chip-programming devices, such as PAL or EPROM programming devices well-known in the art of computer hardware, may be utilized in addition to or in place of the hardware already depicted.

As will be described in detail below, aspects of the preferred embodiment pertain to specific method steps implementable on computer systems. In an alternative embodiment, the invention may be implemented as a computer program-product for use with a computer system, which can be implemented as devices such as networked computer workstations, computer desktop and peripheral devices, servers and the like. The programs defining the functions of the preferred embodiment can be delivered to a computer via a variety of signal-bearing media, which include, but are not limited to, (a) information permanently stored on non-writable storage media (e.g., read-only memory devices within a computer such as CD-ROM disks readable by CD-ROM drive 124); (b) alterable information stored on writable storage media (e.g., floppy disks within diskette drive 122 or hard-disk drive 123); or (c) information conveyed to a computer by a communications media, such as through a computer or telephone network, including wireless communications. Such signal-bearing media, when carrying computer-readable instructions that direct the functions of on or more embodiments present invention, and/or represent alternative embodiments of the present invention.

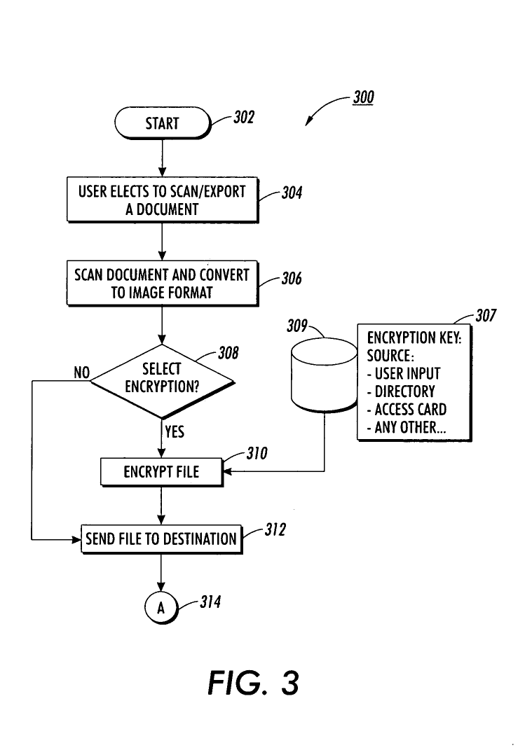

With reference now to FIG. 3, there is illustrated a high-level flow chart 300 of operations depicting logical operational steps that can be implemented in accordance with a preferred embodiment of the present invention. The process is initiated, as indicated at block 302 and thereafter, as depicted at block 304, an operation can be performed in which a user elects to scan and/or export a document. Next, as indicated at block 306, the document is scanned and converted to a particular image format (e.g., PDF, JPEG, GIFF, etc.). Next, as depicted at block 308, a test can be performed to determine if an encryption option is selected. In other words, is the document to be encrypted? If not, then the document is electronically forwarded to its final destination without encryption via the operation described at block 312.

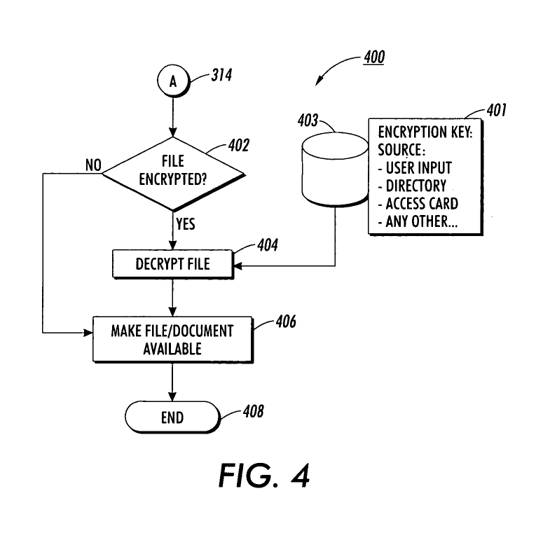

If, however, the document is to be encrypted, then as indicated at block 310, the document is encrypted. Encryption/decryption data (e.g., an encryption/decryption key) can be transferred from a database 307 for use in performing the operation depicted at block 310. Examples of types of encryption/decryption key sources are indicated at block 307. Block 307, together with database 309 and blocks 307, indicate that the data (i.e. file/document) can be encrypted by a number of potential encryption methods, such as fixed encryption (i.e., decoded by a provided application), and/or public key encryption provided by various sources. Such sources can be implemented as active directory data made available by a user login procedure, entry of a local key, availability of a generic key for the device, and/or a key provided by a security card (e.g., smart card, swipe card, etc.). Following processing of the operation depicted at block 312, the operation depicted at continuation block 314 can occur, which indicates that the logical operations continue, as indicated in FIG. 4.

FIG. 4 illustrates a high-level flow chart 400 of operations depicting continuing logical operational steps that can be implemented in accordance with a preferred embodiment of the present invention. Continuation block occurs, as indicated at block 314 in both FIGS. 3-4. Thereafter, as indicated at block 402 a test is performed to determine if the file has been encrypted. If it is determined that the file has not been encrypted then the file (e.g., document) is simply made available for a user without encryption. If, however, it is determined that the file had in fact been encrypted, then the operation indicated at block 404 can be performed in which the file undergoes decryption. During this operation, encryption/decryption data (e.g., an encryption/decryption key) can be transferred from a database 403 for use in decrypting the file/document. Examples of type of encryption key sources are indicated at block 401. For example, the encryption/decryption key can be stored in database 403, which can be implemented as a memory location of an access card (e.g., smart card), in a directory, or via user input to the database 403. The document can then be made available to users as indicated at block 406 once it has been decrypted via the operation depicted at block 404. The process can then terminate, as indicated at block 408.

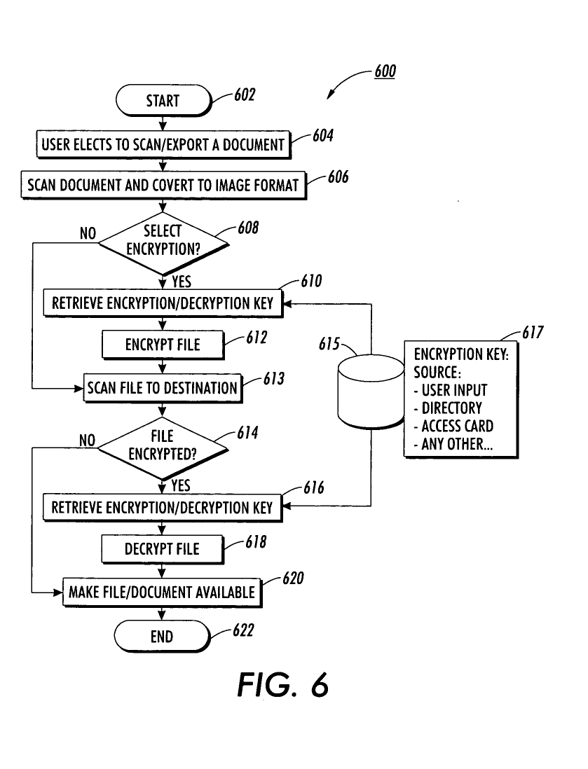

The logical operations depicted FIG. 34 and FIG. 6 can be implemented in the context of a “module” or a group of such modules. In the computer programming arts, a module can be typically implemented as a collection of routines and data structures that performs particular tasks or implements a particular abstract data type. Modules are generally composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based.

Thus, for example, the term module, as utilized herein generally refers to software modules or implementations thereof. Such modules can be utilized separately or together to form a program product that can be implemented through signal-bearing media, including transmission media and recordable media. Flow charts 300-400 of FIGS. 3-4 can therefore be implemented as a module or group of such modules, which are stored within a memory location of data-processing system, such as, for example, data-processing system 112 of FIGS. 1-2.

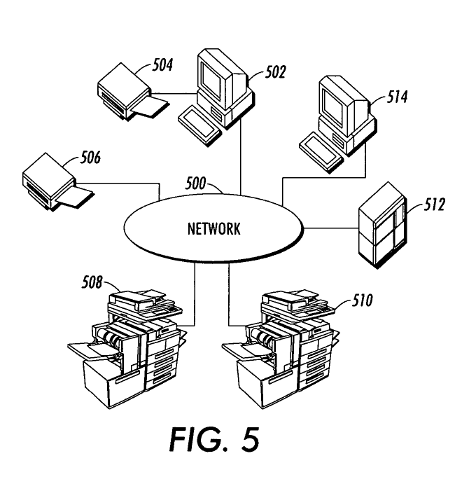

FIG. 5 illustrates a block diagram of a network 500 in which a preferred embodiment can be implemented. Network 500 can be implemented as a computer network through which a variety of data-processing system devices can communicate. An example of network 500 is a LAN. For example, network 500 can communicate with a server 512. Additionally a computer 502 can be linked to a multi-function rendering device 504 or another multi-function rendering device 506 can be linked directly through network 500. Additionally, a computer workstation 514 can be linked to network 500 along with one or more digital copiers 508 and 510. Note that digital copiers 508 can 510 have the capability to scan documents. Thus, documents scanned via copiers 508 and 510 can be saved as computer files (e.g., JPEG, PDF, TIFF, etc) and transmitted to computer 502 for storage within a memory location thereof. The documents stored within a memory location of computer 502 can then be retrieved via computer 502 and rendered via, for example, rendering devices 504 and/or 506, or copiers 508 and/or 510. Computer 502 is generally analogous to data-processing system 110 of FIG. 1, and thus, the documents scanned via copiers 508 can be stored within a memory location of data-processing system 110 and process via a processor such as CPU 226 and/or a CPU associated within any of the other rendering devices, such rendering devices 504, 506 and/or copiers 508, 510.

Note that a variety of different types of rendering devices can be adapted for utilization with preferred or alternative embodiments. For example, different types of copiers can utilized to implement copiers 508 and 510. An example of such a copier is disclosed in U.S. Pat. No. 6,636,899, “Architecture for Software for Remote Maintenance of a Machine Such as a Copier,” which is assigned to the Xerox Corporation and issued to Rabb, et al on Oct. 21, 2003. Another example of a copier, which can be utilized in accordance with an embodiment, is disclosed in U.S. Pat. No. 6,587,227, “Copier Having Contoured Track Guides,” which is also assigned to the Xerox Corporation and issued to Jack K. Fullerton on Jul. 1, 2003.

A further example of a copier, which can be utilized in accordance with an embodiment, is disclosed in U.S. Pat. No. 6,175,714, “Document Control System and Method for Digital Copiers,” which is assigned to the Xerox Corporation and issued to Peter A. Crean on Jan. 16, 2001. Another example of a copier, which can be utilized in accordance with an embodiment, is disclosed in U.S. Pat. No. 6,057,930, “Architecture for a Digital Copier and Printer for Handling Print Jobs Associated with a Network,” which is assigned to the Xerox Corporation and issued to Blossey et al on May 2, 2000. U.S. Pat. Nos. 6,636,899, 6,587,227, 6,175,714 and 6,057,930 are incorporated herein by reference.

FIG. 6 illustrates a high-level flow chart 600 of operations depicting logical operational steps that can be implemented in accordance with an alternative embodiment of the present invention. The process is initiated, as indicated at block 602 and thereafter, as depicted at block 604, an operation can be performed in which a user elects to scan and/or export a document. Next, as indicated at block 306, the document is scanned and converted to a particular image format (e.g., PDF, JPEG, GIFF, etc.). Next, as depicted at block 608, a test can be performed to determine if an encryption option is selected. In other words, is the document to be encrypted? If not, then the document is electronically forwarded to its final destination without encryption via the operation described at block 613.

If, however, the document is to be encrypted, then as indicated at block 612 an encryption/decryption key can be retrieved from a database 615 (or memory location) for utilization in encrypting the document/file. Such a database 615 or memory location can be, for example, a memory location of smart card. Alternatively, a user can enter the encryption key into database 615, from which the encryption key is immediately retrieved for encryption operations thereof, as indicated by block 612. Examples of types of encryption/decryption key sources are indicated at block 617. Following processing of the operation depicted at block 612, the file/document can be sent to its final destination, which may be, for example a memory location of another data-processing system or simply a rendering via a copier or printer.

Prior to rendering or storage, however, another test can be performed, as indicated at block 614, to determine if the file has been encrypted If it is determined that the file has not been encrypted then the file (e.g., document) is simply made available as indicated at block 620 for a user without encryption. If, however, it is determined that the file has in fact been encrypted, then the encryption/decryption key can be retrieved as indicated at block 616 from the database 615 (or another memory location). The encryption/decryption key can then be utilized to decrypt the file/document, as indicated at block 618. Examples of type of encryption key sources are indicated at block 401. The document can then be made available to users as indicated at block 620 once it has been decrypted via the operation depicted at block 620. The process can then terminate, as indicated at block 622.

The operations depicted at blocks 608, 610, 612, and 617 can therefore implement an encryption module for encrypting image formatted data at said scanning device utilizing an encryption key prior to transmitting said image formatted data to its final destination. Similarly, the operations depicted at blocks 614, 616, 617, and 618 can implement a decrypting module for decrypting said image formatted data utilizing an encryption key after said image formatted data is delivered to its final destination. Recall that the term module defined here generally refers to a software module or group of such modules.

An example of an encryption technique, which may be utilized in accordance with one or more embodiments is disclosed in U.S. Pat. No. 6,350,020, “Group Oriented Public Key Encryption and Key Management System,” which is assigned to Fuji Xerox Col., Ltd., and issued to Ryuichi Aoiki on Mar. 4, 2003. Another example of an encryption technique, which may be utilized in accordance with one or more embodiments, is disclosed in U.S. Pat. No. 5,003,597, “Method and Apparatus for Data Encryption,” which is assigned to the Xerox Corporation, and issued to Ralph C. Merkle on Mar. 26, 1991. U.S. Pat. Nos. 6,350,020 and 5,003,597 are incorporated herein by reference.

Based on the foregoing it can be appreciated that embodiments relate to methods and systems for scanning and encrypting documents. A document can be scanned utilizing a scanning device. The document can then be converted into image formatted data representative of the document. The image formatted data can then be encrypted at the scanning device utilizing an encryption key prior to transmitting the image formatted data to its final destination. The image formatted data can be decrypted utilizing an encryption key after the image formatted data is delivered to its final destination, which can be, for example, a rendering device such as a copier or printer linked to a computer network. Embodiments disclosed herein generally permit the encryption of scanned data sent “off the box”. Such data can be encrypted utilizing a variety of encryption techniques, such as, for example, fixed encryption and/or public key encryption.

Directory data can be made available to use after a user authenticated login procedure, entry of a local key, and/or the availability of a generic key for the scanning device, a key provided by a security card (e.g., a smart card, swipe card, etc.). Upon receipt of the file/document, the user can then decrypt the file and view its contents. The embodiments disclosed herein thus describe a scanner or multifunction device function that provides a user with the option to encrypt jobs prior to sending such jobs to their final destination (e.g., client or network storage device). Once at the client, the job can be decrypted and stored according to normal storage procedures. Such embodiments can prevent unauthorized individuals from viewing the data.

It can be appreciated that various other alternatives, modifications, variations, improvements, equivalents, or substantial equivalents of the teachings herein that, for example, are or may be presently unforeseen, unappreciated, or subsequently arrived at by applicants or others are also intended to be encompassed by the claims and amendments thereto.

1. A method, comprising:
scanning a document utilizing a scanning device and converting said document into image formatted data representative of said document;
encrypting said image formatted data at said scanning device utilizing an encryption key prior to transmitting said image formatted data to its final destination; and
decrypting said image formatted data utilizing an encryption key after said image formatted data is delivered to its final destination.

2. The method of claim 1 further comprising retrieving said encryption from a memory location.

3. The method of claim 2 wherein said memory location is associated with scanning device.

4. The method of claim 2 wherein said memory location is associated with said final destination.

5. The method of claim 1 wherein said final destination comprises at least one rendering device.

6. The method of claim 5 further comprising:
linking said scanning device to a computer network; and
linking said at least one rendering device to said computer network.

7. The method of claim 1 further comprising automatically rendering said image formatted data as a copy of said document at said final destination, in response to decrypting said image formatted data utilizing said encryption key after said image formatted data is delivered to said final destination.

8. The method of claim 1 wherein said encryption key is stored within a memory location of a smart card.

9. The method of claim 8 further comprising the step of:
analyzing said smart card and said memory location thereof in order to identify and retrieve said encryption key from said memory location prior to encrypting said image formatted data at said scanning device utilizing an encryption key prior to transmitting said image formatted data to its final destination.

10. A system, comprising:
a scanning device for scanning a document and converting said document into image formatted data representative of said document;
an encryption module for encrypting said image formatted data at said scanning device utilizing an encryption key prior to transmitting said image formatted data to its final destination; and
a decryption module for decrypting said image formatted data utilizing an encryption key after said image formatted data is delivered to its final destination.

11. The system of claim 10 further comprising a memory location from which retrieving said encryption key can be retrieved.

12. The system of claim 11 wherein said memory location is associated with scanning device.

13. The system of claim 11 wherein said memory location is associated with said final destination.

14. The system of claim 10 wherein said final destination comprises at least one rendering device.

15. The system of claim 14 wherein
said scanning device communicates with a computer network; and
said at least one rendering device communicates with said computer network.

16. The system of claim 10 wherein said image formatted data is automatically rendered as a copy of said document at said final destination, in response to decrypting said image formatted data utilizing said encryption key after said image formatted data is delivered to said final destination.

17. A system, comprising:
a computer network;
a scanning device for scanning a document and converting said document into image formatted data representative of said document, wherein said scanning device communicates with said computer network; and
an encryption module for encrypting said image formatted data at said scanning device utilizing an encryption key prior to transmitting said image formatted data to its final destination;
a decryption module for decrypting said image formatted data utilizing an encryption key after said image formatted data is delivered to its final destination, wherein said final destination comprises at least one rendering device that communicates with said computer network; and
wherein said image formatted data is automatically rendered as a copy of said document at said final destination, in response to decrypting said image formatted data utilizing said encryption key after said image formatted data is delivered to said final destination

18. The system of claim 17 wherein said encryption key is stored within a memory location of a smart card.

19. The system of claim 18 wherein said encryption module automatically analyzes said smart card and said memory location thereof in order to identify and retrieve said encryption key from said memory location prior to encrypting said image formatted data at said scanning device utilizing an encryption key prior to transmitting said image formatted data to its final destination.

20. The system of claim 17 wherein said scanning device and said at least one rendering device together comprise a digital copier capable of scanning and rendering documents.
